(19) United States
(12) Patent Application Publication
(10) Pub. No.: US 2026/0209457 A1
(43) Pub. Date: Jul. 23, 2026

(54) SILICONE POLYETHER OFFERING STABILITY FOR POLYOL SYSTEMS WITH HYDROCARBON BLOWING AGENTS

(71) Applicants: Dow Silicones Corporation, Midland, MI (US); Dow Global Technologies LLC, Midland, MI (US)

(72) Inventors: Simon Toth, Midland, MI (US); Frank Zhang, Midland, MI (US); Scott Boelter, Midland, MI (US); Adebola Ogunniyi, Lake Jackson, TX (US); Jochem Kersbulck, Hoek (NL)

(21) Appl. No.: 19/138,353

(22) PCT Filed: Nov. 14, 2023
(86) PCT No.: PCT/US2023/079612

§ 371 Date: Jun. 12, 2025

Related U.S. Application Data
(60) Provisional application No. 63/438,019, filed on Jan. 10, 2023.

(51) Int. Cl. C08J 9/00; C08J 9/14; C08L 75/08

(52) U.S. Cl. CPC C08J 9/0061; C08J 9/141; C08L 75/08; C08J 2201/022; C08J 2203/14; C08J 2375/08; C08J 2483/12; C08L 2203/14

(57) ABSTRACT

A polyol composition comprises a polyol, blowing agent, and a silicone polyether with an average chemical formula R₃SiO(R₂SiO)ₓ(RR^{a}SiO)_{y}SiR₃ where R is a C₁₋₄ alkyl, x is 5-55, y is 1-10, x+y is 6-60, R^{a} has an average chemical formula —(CH)ₚ-(EO)ₙ(PO)ₘ(EO)ₑH where EO is —CH₂CH₂O—, PO is —CH₂CH(CH₃)O—, e is 1-50, m is 2-10, n is 1-20, e+n is 25-70, p is one to 10, the PO content is >0 and <15 weight-percent of the weight of EO+PO, the EO content is >58 and <75 weight-percent of the silicon polyether weight, and the blowing agent is >70 volume-percent hydrocarbon blowing agent based on blowing agent volume and at least one of the following is true: (i) R^{a} has a number average molecular weight in a range of 1500 to 2500 grams per mole as determined by size exclusion chromatography; and (ii) the x+y is 50 or less.

### FIELD OF THE INVENTION

The present invention provides a particularly stable polyol composition useful in preparing polyurethane foam and utilizes a silicone polyether as a stabilizer.

### INTRODUCTION

Two-part systems for preparing polyurethane foam comprise a part “A” part and part “B”. Part A comprises isocyanate functional components. Part B is a polyol formulation that comprises one or a combination of multiple polyols and often a blowing agent. Upon mixing Parts A and B, the polyol of part B reacts with the isocyanate functionalities in part A to form polyurethane foam.

The blowing agent in part B historically has been halogenated materials with high ozone depleting ang high global warming potential. However, it is environmentally more desirably to use blowing agents with lower ozone depleting and global warming potential than halogenated blowing agents. One alternative is to use a hydrocarbon blowing agent. A challenge is achieving compatibility between hydrocarbon blowing agents and polyols, particularly polyether polyols, especially with increasing content of ethylene oxide (EO) in the polyether polyol. As the EO content of a polyether polyol increases the compatibility with hydrocarbon blowing agents tends to decrease, resulting in phase separation of the blowing agent from the polyether polyol in the part B component often in a matter of minutes. Phase separation leads to inhomogeneous distribution of the blowing agent in the polyol, which in turn results in inhomogeneous foaming when mixed with the part A component to produce foam with non-uniform color, textures, poor rise, and/or large holes.

Instability of the part B component can be particularly problematic when storage temperatures can vary over a range from 10-30 degrees Celsius (° C.) depending on the geography and environment they are in.

It is desirable to identify a compatibilizing agent that is useful in part B formulations comprising hydrocarbon blowing agents and polyether polyols for stabilizing phase separation from occurring for a matter of days over a temperature range of 10-30° C. Such a compatibilizing agent would advance the art of polyurethane foam manufacturing by enabling formulation and storage of part B formulations for longer periods of time without requiring constant mixing or production of poor-quality foam due to polyol/blowing agent phase separation.

It is desirable to identify a compatibilizing agent that is useful in part B formulations comprising hydrocarbon blowing agents and polyether polyols for stabilizing phase separation from occurring for a matter of days over a temperature range of 10° C. to 30° C. Such a compatibilizing agent would advance the art of polyurethane foam manufacturing by enabling formulation and storage of part B compositions for longer periods of time without requiring constant mixing or production of poor-quality foam due to polyol/blowing agent phase separation.

### BRIEF SUMMARY OF THE INVENTION

The present invention provides a silicone polyether that works as a compatibilizing agent that is useful in part B formulations comprising hydrocarbon blowing agents and polyether polyols for stabilizing phase separation from occurring for a matter of days over a temperature range of 10-30° C.

In a first aspect, the present invention is a polyol composition comprising a polyol, a blowing agent, and a silicone polyether, wherein the silicone polyether has an average chemical formula (I): R₃SiO(R₂SiO)ₓ(RR^{a}SiO)_{y}SiR₃ (I), where (a) each R is independently in each occurrence selected from alkyl groups having from one to 4 carbon atoms; (b) subscript x has an average value in a range of 5 to 55; (c) subscript y has an average value in a range of one to 10; (d) the sum of x+y has an average value in a range of 6 to 60; and (e) R^{a} has an average chemical formula (II): —(CH₂)ₚ-(EO)ₙ(PO)ₘ(EO)ₑH (II), where: (i) EO refers to —CH₂CH₂O—; (ii) PO refers to —CH₂CH(CH₃)O—; (iii) subscript e has an average value in a range of one to 50; (iv) subscript m has an average value in a range of 2 to 10; (v) subscript n has an average value in a range of one to 20; (vi) the sum of subscript e and n has an average value in a range of 25 to 70; and (vii) subscript p has an average value in a range of one to 10; provided that the PO content is greater than zero and at the same time less than 15 weight-percent of the combined weight of EO and PO, the EO content is greater than 58 weight-percent and at the same time less than 75 weight-percent of the weight of the silicone polyether, and wherein the blowing agent is more than 70 volume-percent hydrocarbon blowing agent based on blowing agent volume and wherein at least one of the following conditions is met: (f) R^{a} has a number average molecular weight in a range of 1500 to 2500 grams per mole as determined by size exclusion chromatography; and (g) the sum of the average value for subscripts x and y is 50 or less.

In a second aspect, the present invention is a process for preparing polymeric foam, the process comprising combining the polyol composition of any one previous claim with a composition comprising isocyanate functional components. The process can include first preparing the polyol composition and then allowing it to age for a day or longer at a temperature in a range of 10 to 30° C. prior to combining with a composition comprising isocyanate functional components.

The present invention is useful for preparing stable part B compositions for use in preparing polyurethane foam.

### DETAILED DESCRIPTION OF THE INVENTION

Test methods refer to the most recent test method as of the priority date of this document when a date is not indicated with the test method number. References to test methods contain both a reference to the testing society and the test method number. The following test method abbreviations and identifiers apply herein: ASTM refers to American Society for Testing and Materials; EN refers to European Norm; DIN refers to Deutsches Institut für Normung; and ISO refers to International Organization for Standards.

“Multiple” means two or more. “And/or” means “and, or as an alternative”. All ranges include endpoints unless otherwise indicated.

Products identified by their tradename refer to the compositions available under those tradenames on the priority date of this document.

“Ca-b”, “C_{a-b}” are interchangeable and refer to having from a to b carbon atoms.

“Polyurethane” refers to polymeric materials with multiple urethane links. The term “polyurethane” includes “polyisocyanurate” unless expressly indicated otherwise. Polyisocyanurate is a form of polyurethane typically formed from a polyhydroxy material and a component with multiple isocyanate groups such as a diisocyanate. Polyisocyanurates are often prepared from derivatives of cyanuric acid.

In one aspect, the present invention is a polyol composition comprising a polyol, a blowing agent, and a silicone polyether.

The polyol of the polyol composition can be a polyester polyol and/or a polyether polyol. Desirably, the polyol is a polyether polyol. Suitable polyester polyols desirably have an average functionality of 1.8 to 8, preferably 1.8 to 5 and more preferably about 2 to 2.5. The hydroxyl number values for the polyester polyols generally are 15 or more, preferably 30 or more and more preferably 100 or more while at the same time is generally 750 or less, preferably 550 or less, and more preferably 250 or less. Free glycol content of the polyester polyols generally is 0 or more, preferably 2 or more, while at the same time is generally 40 or less, preferably 30 or less, and more preferably 15 or less. The acid number for the polyester polyol is generally 0.2 or greater. Suitable polyether polyols include linear and branched chain polyether polyols that have a plurality of acyclic ether oxygens and that contain at least 1.8, preferably 3 or more and typically 4 or more while at the same time typically have 8 or fewer isocyanate-reactive groups. The polyether polyols typically have molecular weights, based on their hydroxyl values, ranging from 250 to 7500. “Isocyanate-reactive groups” include, and can be, hydroxyl (—OH) groups. The polyol can comprise greater than 50 weight-percent EO based on alkoxy weight in the polyol.

Typically, the polyol composition contains polyol at a concentration of 50 weight-percent or more, and can be 55 wt % or more while at the same time is typically present at a concentration of 95 wt % or less, 90 wt %, or even 85 wt % or less based on the polyol composition weight.

The blowing agent can be a single compound or can be a combination of more than one compound provided the blowing agent is more than 70 volume-percent (vol %) hydrocarbon blowing agent based on blowing agent volume. “Hydrocarbon blowing agent” refers to one or a combination of more than one hydrocarbon with an average molecular weight of up to 72 grams per mole and a boiling point in range of −5 degrees Celsius (° C.) or higher, −1° C. or higher, 25° C. or higher, 27.8° C. or higher, even 36° C. or higher, while at the same time is typically 100° C. or lower, preferably 70° C. or lower, and can be 40° C. or lower. The blowing agent can be a combination of blowing agents where the blowing agent is 75 vol % or more, 80 vol % or more, 85 vol % or more, 90 vol % or more, even 95 vol % or more hydrocarbon blowing agent based on blowing agent volume. Desirably, the blowing agent is 100 vol % hydrocarbon blowing agent based on blowing agent volume. Examples of suitable hydrocarbon blowing agents include butane (C4 hydrocarbon) including each isomer, pentane (C5 hydrocarbon) including each isomer, and combinations thereof. Desirably, the polyol composition is free of hydrofluorocarbons and hydrochlorofluorocarbons, which are often present as blowing agents. Even more desirably, the polyol composition is free of halogenated blowing agents.

Typically, the polyol composition contains one wt % or more, preferably 5 wt % or more while at the same time typically 30 wt % or less, preferably 25 wt % or less blowing agent based on polyol composition weight.

The polyol composition comprises a silicone polyether. The silicone polyether has an average chemical Formula (I):

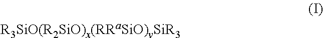

where:
Each R is independently in each occurrence selected from alkyl groups having from one to 4 carbon atoms, and can have one or more, two or more, three or more, even four carbon atoms while at the same time has 4 or fewer, and can have 3 or fewer, 2 or fewer even can have one carbon atom and R is desirably the same in each occurrence and can be methyl in each occurrence;
subscript x has an average value in a range of 5 to 55, and can have an average value of 5 or more 10 or more, 14 or more, 20 or more, 21 or more, even 23 or more while at the same time is typically 55 or less, and can be 50 or less, 40 or less, 30 or less 23 or less, 21 or less, even 20 or less;
subscript y has an average value in a range of one to 10, and can have an average value of one or more, 2 or more, 3 or more, 4 or more while at the same time is typically 10 or less, and can be 9 or less, 8 or less, 7 or less, 6 or less, 5 or less, even 4 or less;
the sum of x+y has an average value in a range of 6 to 60; and can have an average value of 6 or more, 10 or more, 15 or more, 16 or more, even 20 or more while at the same time is typically 60 or less, and can be 50 or less, 40 or less, 30 or less, 27 or less, 26 or less, 25 or less, 24 or less, even 23 or less; and R^{a} has an average chemical formula (II):

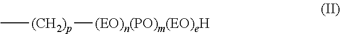

where:
   (i) EO refers to —CH₂CH₂O—;
   (ii) PO refers to —CH₂CH(CH₃)O—;
   (iii) subscript e has an average value in a range of one to 50, and typically has an average value of one or more, and can have an average value of 5 or more; 10 or more, even 20 or more while at the same time is typically 50 or less, and can be 40 or less, 30 or less, even 20 or less;
   (iv) subscript m has an average value in a range of 2 to 10, and typically has an average value of 2 or more, even 2.5 or more while at the same time 10 or less, and can be 8 or less, 6 or less, 4 or less, even 3 or less;
   (v) subscript n has an average value in a range of one to 20, and typically has an average value of one or more, and have an average value of 5 or more, 10 or more, even 11 or more while at the same time is typically 20 or less, and can be 15 or less, even 11 or less;
   (vi) the sum of subscript e and n has an average value in a range of 25 to 70, and typically has an average value of 25 or more and can be 30 or more, even 31 or more while at the same time is typically 70 or less, and can be 50 or less, 40 or less, 35 or less, even 31 or less; and
   (vii) subscript p has an average value in a range of one to 11, and typically has an average value of one or more and can have 2 or more, 3 or more, 4 or more, 5 or more, 6 or more, even 7 or more while at the same time typically has an average value of 11 or fewer, and can have a value of 10 or fewer, 9 or fewer, 8 or fewer, 7 or fewer, 6 or fewer, 5 or fewer, 4 or fewer, even 3 or fewer;
provided that:
the PO content is greater than zero and at the same time less than 15 weight-percent (wt %) of the combined weight of EO and PO, and typically is present at a concentration of more than zero, and can be present at a concentration of 2 wt % or more, 4 wt % or more, 6 wt % or more, 8 wt % or more, even 9 wt % or more, or 9.5 wt % or more while at the same time 15 wt % or less, or even 12 wt % or less, even 10 wt % or less, or 9.5 wt % or less based on the combined weight of EP and PO in the silicone polyether; and
the EO content is greater than 58 weight-percent and at the same time less than 75 wt % of the weight of the silicone polyether, and can be 58 wt % or more, 59 wt % or more, 60 wt % or more, 61 wt % or more, 62 wt % or more, 63 wt % or more, even 64 wt % or more while at the same time is typically 75 wt % or less, and can be 70 wt % or less, 66 wt % or less, 65 wt % or less, 63 wt % or less, even 60 wt % or less based on weight of the silicone polyether; and
wherein at least one of the following two conditions are met:
R^{a} has a number average molecular weight in a range of 1500 to 2500 grams per mole (g/mol), and is preferably 1500 g/mol or more, and can be 1600 g/mol or more, 1700 g/mol or more, 1800 g/mol or more, 1900 g/mol or more, 2000 g/mol or more, 2100 g/mol or more, 2200 g/mol or more, 2300 g/mol or more, even 2400 g/mol or more while at the same time is typically 2500 g/mol or less, and can be 2400 g/mol or less, 2300 g/mol or less, 2200 g/mol or less, 2100 g/mol or less, 2000 g/mol or less, 1900 g/mol or less, 1800 g/mol or less, 1700 g/mol or less, even 1600 g/mol or less; and
the sum of the average value of subscripts x and y is 50 or less, and can be 40 or less, 30 or less, 27 or less, 24 or less, 23 or less, 20 or less, 18 or less, even 16 or less while at the same time can be 6 or more, 10 or more, 12 or more, 14 or more, 15 or more, 16 or more, 18 or more, 20 or more, even 23 or more.

Determine the structure and number average molecular weight for the silicone polyether by nuclear magnetic resonance (NMR) spectroscopy using ¹H-NMR, ²⁹Si-NMR and ¹³C-NMR. Collect ¹H-NMR spectra on an Agilent 400MR NMR spectrometer (9.4T) equipped with a 5 millimeter (mm) OneNMR probe. Prepare samples for ¹H-NMR by dissolving 0.150 grams of sample in one gram of benzene-d6 solvent. Use the following parameters to collect ¹H-NMR spectra: 16 transients with 5 second acquisition time, 15 second relaxation time. Process spectra with ACD/Spectrus Process (2012 release Build 66513) from www.acdlabs.com.

Collect ²⁹Si-NMR and ¹³C-NMR spectra using an Agilent DDR2NMR spectrometer (11.7 T) equipped with a 16 millimeter (mm) silicon-free AutoX probe. Prepare samples for ²⁹Si-NMR and ¹³C-NMR by dissolving 6 grams of sample in 2.7 grams of benzene-d6 solvent with chromium acetylacetonate relaxation agent at 0.05 molar concentration. Use the following parameters to collect ²⁹Si-NMR spectra: 1024 transients, one second acquisition time, 16 second relaxation time. Use the following parameters to collect ¹³C-NMR spectra: 1024 transients, one second acquisition time, 13 second relaxation time. Process spectra with ACD/Spectrus Process (2012 release Build 66513) from www.acdlabs.com.

Use ²⁹Si-NMR spectra to calculate silicone polyether chain parameters. Define a reference with the tallest peak at δ=−22.0 ppm, integral value at δ=7.15+/−0.1 ppm is set to 2. The value of integration at δ=−22.00+/−0.1 ppm provides the chain length (“x”) and the value of integration at δ=−22.45+/−0.1 ppm provides the number of polyether chains (“y”).

Use ¹³C-NMR to calculate polyether chain structure parameters. Set the reference to C₆H₆ middle peak at δ=128.39 ppm, integral value at δ=14.21+/−0.1 ppm is set to “y”, which represent the average number of polyether chains attached to the silicone polyether backbone. Calculate the total number of polyether chains not attached to the silicone polyether backbone by adding the average integral value of signals at δ=98.19+/−0.1 ppm and 6=147.64+/−0.1 ppm (“a1”), the average integral value of signals at δ=100.58+/−0.1 ppm and δ=146.91+/−0.1 ppm (“a2”), and the average integral value of signals at δ=116.34+/10.1 ppm and 6=136.11+/−0.1 ppm (“a3”). The total number of polyether chains is the sum of attached and non-attached polyether chains (t=a1+a2+a3+y). Calculate the average number of ethylene oxide (EO) groups (“e”) in a polyether chain, divide the integral value of signal between δ=68.5 ppm and δ=72.5 ppm by 2t. Calculate the average number of propylene oxide (PO) groups (“m”) in a polyether chain, subtract “y” from the integral value of signal between δ=72.5 ppm and δ=78.5 ppm and then divide by 2t. Identify the average value of subscript p by the sum of the integral value signals at δ=14.21+/−0.1 ppm, δ=24.05+/−0.1 ppm and δ=74.17+/−0.1 ppm.

Use 1H-NMR to verify the values of a1, a2, and a3.

Calculate the number average molecular weight based on the above parameters obtained from the NMR spectra. Number average molecular weight=162+74x+(59+14n+44e+58p+z)y, where “z” has a value of one for the terminal hydrogen on the pendant polyether group. The number average molecular weight for pendant polyether chain is (59+14n+44e+58p+z).

The polyol composition can have organopolysiloxanes present other than the silicone polyether of Formula (I). For example, the polyol composition can have an organopolysiloxane present that is a variation of the silicone polyether of Formula (I) that has the chemical Formula (II) terminated with a non-primary OH. Desirably, the polyol composition contain 5 mole-percent (mol %) or less, preferably 4 mol % or less, 3 mol % or less, 2 mol % or less, even one mol % or less, and can be free of a variation of the silicone polyether of Formula (I) that has the chemical Formula (II) terminated with a non-primary OH, with mol % based on combined moles of silicone polyether of Formula (I) and organopolysiloxanes that have the structural variation of Formula (I).

The silicone polyether is typically present in the polyol composition at a concentration of 0.5 wt % or more, preferably 1.5 wt % or more while at the same time 5 wt % or less, preferably 4 wt % or less based on polyol composition weight.

The polyol composition can comprise additional components. Additional components include, for example, any one or any combination of more than one of the following: fire retardants (such as tris(chloroisopropyl)phosphate and triethyl phosphate), water, catalysts, colorants, diluents, thickeners, and fillers.

In a second aspect, the present invention is a process for preparing polymeric foam, the process comprising combining the polyol composition of the present invention together with a composition comprising isocyanate functional components. One of the benefits of the polyol composition of the present invention is that it is particularly stable to phase separation, particularly separation of the blowing agent from the polyol. Such stability allows for preparation of the polyol composition and storage of the polyol composition prior to combining with a composition comprising isocyanate functional components to make polymeric foam. Therefore, the process of the present invention can comprise first preparing the polyol composition and then allowing it to age for a day or longer at a temperature in a range of 10 to 30° C. prior to combining with a composition comprising isocyanate functional components and still can make polymeric foam with uniform cell size without large holes.

### Examples

Prepare silicone polyethers for the following Examples (Exs) and Comparative Examples (Comp Exs) by first preparing siloxane reactants and polyether reactants and then reacting a polyether reactant with a siloxane reactant to obtain the silicone polyether.

### Preparation of Siloxane Reactants

Table 1 lists the components for preparing siloxane reactants.

TABLE 1

| Component | Description | Source |
|---|---|---|
| SiH | Polymethylhydrosiloxane, | Available under the |
| Siloxane | trimethylsilyl terminated 30 | name XIAMETER ™ |
| | square millimeter per | MHX-1107 Fluid 30 |
| | second (centistoke) | cSt from The Dow |
| | | Chemical Company. |
| Cyclic | Octamethylcyclotetrasiloxane, | Available under the |
| siloxane | CAS 556-67-2 | name DOWSIL ™ 2444 |
| | | Fluid from The Dow |
| | | Chemical Company |
| Endblock | Hexamethyldisiloxane, | Available under the |
| siloxane | CAS 107-46-0 | name DOWSIL ™ |
| | | 2-1374 from The Dow |
| | | Chemical Company. |
| Catalyst | Trimethanesulfonic acid, | Available from |
| | CAS 1493-13-6 | Sigma-Aldrich |
| Neutralizing | Sodium bicarbonate, | Available from |
| agent | anhydrous, >99.7% | Sigma-Aldrich |

XIAMETER is a trademark of the Dow Silicones Corporation. DOWSIL is a trademark of The Dow Chemical Company.

Prepare siloxane reactants 1-8 using the following procedure with reference to Table 2 for wt % of components and characteristics of the resulting Siloxane 1-8 products.

Load the appropriate amount of cyclic siloxane, SiH siloxane, and endblock siloxane into a 3-neck flask equipped with a thermocouple, cold water-cooled condenser, and mechanical stirring (glass rod with polytetrafluoroethylene paddle). Purge the flask with nitrogen for 15 seconds to avoid volatilizing the endblock siloxane. Add 500 weight-parts per million (ppm) catalyst based on total component weight to form a reaction mixture. Heat the reaction mixture to 60 degrees Celsius (° C.) using an aluminum heating block and hold at that temperature for 8 hours while stirring. After the 8 hours, stop heating and neutralize the contents of the flask by adding neutralizing agent at a concentration of 2 wt % based on flask content weight. Stir the contents of the flask for 12 hours and then filter through 5 micrometer filter paper to remove solids. The resulting material is the siloxane reactant having an average structure of Formula (Ia):

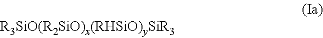

Characterize the siloxane reactant as described hereinabove. Results are in Table 2 with values for variables from Formula (Ia).

TABLE 2

| Siloxane | wt % SiH | wt % cyclic | wt % endblock | | | |
|---|---|---|---|---|---|---|
| Reactant | siloxane | siloxane | siloxane | R | X | Y |
| 1 | 16.1 | 77.8 | 6.2 | Methyl | 30 | 7 |
| 2 | 11.2 | 80.7 | 8.1 | Methyl | 23 | 3.6 |
| 3 | 8.2 | 80.0 | 11.7 | Methyl | 50 | 7.2 |
| 4 | 10.4 | 86.3 | 3.3 | Methyl | 50 | 7.2 |
| 5 | 22.2 | 62.9 | 14.9 | Methyl | 8.7 | 3.7 |
| 6 | 16.1 | 77.8 | 6.2 | Methyl | 25 | 6 |
| 7 | 11.8 | 80.9 | 7.3 | Methyl | 32 | 4 |
| 8 | 8.2 | 80.0 | 11.7 | Methyl | 14 | 2 |

### Preparation of Polyether Reactants

Table 3 lists the components for preparing polyether reactants.

TABLE 3

| Component | Description | Source |
|---|---|---|
| Initiator 1 | Allyl alcohol, | Sigma-Aldrich |
| | CAS 107-18-6 | |
| Alkylene | Ethylene oxide, | The Dow Chemical |
| Oxide 1 | CAS 75-21-8 | Company or |
| | | Sigma-Aldrich |
| Alkylene | 1,2-propylene oxide, | The Dow Chemical |
| Oxide 2 | CAS 75-56-9 | Company or |
| | | Sigma-Aldrich |
| Catalyst | Potassium hydroxide | Univar |
| | solution, 45% | |
| | in water | |
| Absorbent | Magnesium Silicate, | Available as |
| | CAS 1343-88-0 | AMBOSOL ™ MP25 |
| | | from PQ Corporation. |

AMBOSOL is a trademark of PQ Corporation.

Prepare 12 polyether reactants using a 17.1-liter stainless steel reactor that is temperature controlled with an external thermostatic control units. Use an oxide dosing system that is controlled by weight and limited by a maximum pressure in the reactor of 0.4 Megapascals (4.0 bar). Oxide feeding automatically stops after feed the desired amount.

Table 4 provides the amounts of each reactant used in preparing the polyether reactants and a characterization of the polyether reactants. Each polyether reactant has an average chemical structure of Formula (III) and Table 4 identifies the average values for variables of Formula (III) for the 12 polyether reactants:

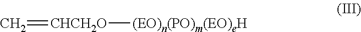

TABLE 3

| | | | Addition | Addition | Addition | | | | | mol % with |
|---|---|---|---|---|---|---|---|---|---|---|
| | | | 1: Alkylene | 2: Alkylene | 3: Alkylene | | | | | terminal |
| Polyether | | Initiator | oxide 1 | Oxide 2 | oxide 1 | Catalyst | | | | primary |
| Reactant | Initiator | (g) | (g) | (g) | (g) | (g) | n | m | e | OH |
| 1 | Allyl alcohol | 126.3 | 2874 | 0 | 0 | 11.6 | 30 | 0 | 0 | >95 |
| 2 | Polyether | 1315 | 0 | 340 | 1344 | 12.58 | 11 | 2.5 | 13 | >90 |
| | Reactant 11 | | | | | | | | | |
| 3 | Polyether | 1235 | 0 | 320 | 1944 | 11.75 | 11 | 2.5 | 20 | >95 |
| | Reactant 11 | | | | | | | | | |
| 4 | Polyether | 1236 | 0 | 686 | 989 | 12.66 | 11 | 5 | 9.5 | >85 |
| | Reactant 11 | | | | | | | | | |
| 5 | Polyether | 1236 | 0 | 321 | 1952 | 11.91 | 11 | 2.5 | 20 | >95 |
| | Reactant 11 | | | | | | | | | |
| 6 | Allyl alcohol | 115.2 | 2885 | 0 | 0 | 10.6 | 33 | 0 | 0 | >95 |
| 7 | Allyl alcohol | 238 | 1808 | 953 | 0 | 22 | 10 | 4 | 0 | <15 |
| 8 | Allyl alcohol | 228.3 | 2772 | 0 | 0 | 21.1 | 16 | 0 | 0 | >95 |
| 9 | Allyl alcohol | 150.3 | 2850 | 0 | 0 | 13.9 | 25 | 0 | 0 | >95 |
| 10 | Allyl alcohol | 134.9 | 2865 | 0 | 0 | 12.4 | 28 | 0 | 0 | >95 |
| 11 | Allyl alcohol | 310.9 | 2689 | 0 | 0 | 28.7 | 11 | 0 | 0 | >95 |
| 12 | Polyether | 1044.5 | 1647 | 143 | 0 | 9.92 | 30 | 2.5 | 0 | <25 |
| | Reactant 11 | | | | | | | | | |

### Preparation of Polyether Reactants 1, 6, and 8-11

Charge Initiator 1 and catalyst into the reactor at 23° C. Flush the reactor extensively with nitrogen. Bring the reactor contents to 110-115° C. while mixing at approximately 250 revolutions per minute (rpm). Remove water from the starter/catalyst mixture by applying 3 kilopascals (30 millibar) vacuum. After one hour and 30 minutes under vacuum, remove a sample from the reactor and determine water content by titration. Bring the remaining contents of the reactor to about 120 kilopascals (1.2 bar) pressure with nitrogen. Increase the temperature of the reactor contents to 125° C. while stirring at 125 rpm. Add alkylene oxide 1 as addition 1 over 2 hours. Allow the reactor contents to digest for 6 hours and then cool to approximately 70° C. At 60° C., dilute the reactor contents with solvent (88 wt % isopropyl alcohol and 12 wet % water) at a concentration of 20 g solvent per 100 g product. Pass the resulting mixture through ion exchange resin in 75 minutes at 58° C.—first a cationic ion exchange resin (Alfa Aesar™ Diaion™ PK228-Na) followed by a mix bed of equal volumes of the cationic ion exchange resin and anionic ion exchange resin (Alfa Aesar™ Diaion™ PA316-CI). Alfa Aesar is a trademark of Thermo Fisher Limited. Diaion is a trademark of Mitsubishi Chemical Corporation. Remove solvent by applying 2 kilopascals (20 millibar) vacuum using a rotary evaporator at approximately 85° C. and post treat with magnesium silicate absorbent. Filter at 40-70° C. using a Buchner funnel with paper filter type 1288 from Sartorius Stedim Biotech. Characterize the resulting polyether as described hereinabove.

### Preparation of Polyether Reactants 2 and 3

Charge Polyether Reactant 11 and catalyst into the reactor at 23° C. Flush the reactor extensively with nitrogen. Bring the reactor contents to 110-115° C. while mixing at approximately 250 rpm. Remove water from the starter/catalyst mixture by applying 3 kilopascals (30 millibar) vacuum. After 2 hours and 45 minutes under vacuum, remove a sample from the reactor and determine water content by titration. Bring the remaining contents of the reactor to about 120 kilopascals (1.2 bar) pressure with nitrogen. Increase the temperature of the reactor contents to 125° C. while stirring at 125 rpm. Add alkylene oxide 2 as addition 2 over 3 hours. Allow the reactor contents to digest for one minute and add alkylene oxide 1 as Addition 3 over one hour and 40 minutes. Allow the reactants to digest for 6 hours and then cool to approximately 70° C. At 60° C., dilute the reactor contents with solvent (88 wt % isopropyl alcohol and 12 wet % water) at a concentration of 20 g solvent per 100 g product. Pass the resulting mixture through ion exchange resin in 75 minutes at 58° C.—first a cationic ion exchange resin (Alfa Aesar™ Diaion™ PK228-Na) followed by a mix bed of equal volumes of the cationic ion exchange resin and anionic ion exchange resin (Alfa Aesar™ Diaion™ PA316-CI). Alfa Aesar is a trademark of Thermo Fisher Limited. Diaion is a trademark of Mitsubishi Chemical Corporation. Remove solvent by applying 2 kilopascals (20 millibar) vacuum using a rotary evaporator at approximately 85° C. and post treat with magnesium silicate absorbent. Filter at 40-70° C. using a Buchner funnel with paper filter type 1288 from Sartorius Stedim Biotech. Characterize the resulting polyether as described hereinabove.

### Preparation of Polyether Reactants 4 and 5

Charge Polyether Reactant 11 and catalyst into the reactor at 23° C. Flush the reactor extensively with nitrogen. Bring the reactor contents to 110-115° C. while mixing at approximately 250 rpm. Remove water from the starter/catalyst mixture by applying 3 kilopascals (30 millibar) vacuum. After one hour and 30 minutes under vacuum, remove a sample from the reactor and determine water content by titration. Bring the remaining contents of the reactor to about 120 kilopascals (1.2 bar) pressure with nitrogen. Increase the temperature of the reactor contents to 125° C. while stirring at 125 rpm. Add alkylene oxide 2 as addition 2 over one hour. Allow the reactor contents to digest for 4 hours and 30 minutes and add alkylene oxide 1 as Addition 3 over one hour and 40 minutes. Allow the reactants to digest for 6 hours and then cool to approximately 70° C. At 60° C., dilute the reactor contents with solvent (88 wt % isopropyl alcohol and 12 wet % water) at a concentration of 20 g solvent per 100 g product. Pass the resulting mixture through ion exchange resin in 75 minutes at 58° C.—first a cationic ion exchange resin (Alfa Aesar™ Diaion™ PK228-Na) followed by a mix bed of equal volumes of the cationic ion exchange resin and anionic ion exchange resin (Alfa Aesar™ Diaion™ PA316-CI). Alfa Aesar is a trademark of Thermo Fisher Limited. Diaion is a trademark of Mitsubishi Chemical Corporation. Remove solvent by applying 2 kilopascals (20 millibar) vacuum using a rotary evaporator at approximately 85° C. and post treat with magnesium silicate absorbent. Filter at 40-70° C. using a Buchner funnel with paper filter type 1288 from Sartorius Stedim Biotech. Characterize the resulting polyether as described hereinabove.

### Preparation of Polyether Reactant 7

Charge Polyether Reactant 11 and catalyst into the reactor at 23° C. Flush the reactor extensively with nitrogen. Bring the reactor contents to 110-115° C. while mixing at approximately 250 rpm. Remove water from the starter/catalyst mixture by applying 3 kilopascals (30 millibar) vacuum. After one hour and 30 minutes under vacuum, remove a sample from the reactor and determine water content by titration. Bring the remaining contents of the reactor to about 120 kilopascals (1.2 bar) pressure with nitrogen. Increase the temperature of the reactor contents to 125° C. while stirring at 125 rpm. Add alkylene oxides 1 and 2 over 2 hours and then allow to digest for 8 hours before cooling the reactor contents to 70° C. At 60° C., dilute the reactor contents with solvent (88 wt % isopropyl alcohol and 12 wet % water) at a concentration of 20 g solvent per 100 g product. Pass the resulting mixture through ion exchange resin in 75 minutes at 58° C.—first a cationic ion exchange resin (Alfa Aesar™ Diaion™ PK228-Na) followed by a mix bed of equal volumes of the cationic ion exchange resin and anionic ion exchange resin (Alfa Aesar™ Diaion™ PA316-CI). Alfa Aesar is a trademark of Thermo Fisher Limited. Diaion is a trademark of Mitsubishi Chemical Corporation. Remove solvent by applying 2 kilopascals (20 millibar) vacuum using a rotary evaporator at approximately 85° C. and post treat with magnesium silicate absorbent. Filter at 40-70° C. using a Buchner funnel with paper filter type 1288 from Sartorius Stedim Biotech. Characterize the resulting polyether as described hereinabove.

### Preparation of Silicone Polyethers

Prepare 11 Comp Ex silicone polyethers and 6 Ex silicone polyethers using the following procedure.

Charge a 3-neck round bottom flask with polyether reactant, siloxane reactant and isopropyl alcohol solvent (if designated) using the components and amounts in Table 4 to make 500 g batches. Equip the flask with an overhead mechanical stirrer (glass rod with polytetrafluoroethylene paddle), a thermocouple with a nitrogen inlet and a water-cooled condenser connected to a bubbler. Heat the reaction mixture to 70° C. with an aluminum heating block under a slight nitrogen seep and vigorous stirring (275 rpm). Catalyst the reaction with 5 ppm of platinum catalyst (Karstedt catalyst available from Sigma-Aldrich). Once the resulting exotherm subsides, heat the reaction for one hour at 83° C. If solvent is present, remove it slowly by applying a vacuum to the warm reaction mixture while maintaining a temperature above 60° C. Once the vacuum safely reaches below 1.33 kilopascals (10 Torr) raise the temperature to 100° C. and maintain for one hour at 800 pascals (6 Torr). The resulting material is the silicone polyether. Characterize as described herein above. Results of characterization are in Table 5 in terms of variable from Formula (I).

TABLE 4

| | | wt % | | wt % | |
|---|---|---|---|---|---|
| | Siloxane | Silicone | Polyether | Polyether | wt % |
| Sample | Reactant | Reactant | Reactant | Reactant | solvent |
| Comp Ex A | 5 | 73.0 | 11 | 27.0 | 0 |
| Comp Ex B | 6 | 20.1 | 7 | 64.9 | 15 |
| Comp Ex C | 8 | 18.8 | 4 | 47.9 | 33.3 |
| Comp Ex D | 8 | 18.2 | 2 | 48.4 | 33.3 |
| Comp Ex E | 3 | 18.0 | 2 | 48.7 | 33.3 |
| Comp Ex F | 8 | 17.7 | 10 | 49.0 | 33.3 |
| Comp Ex G | 3 | 22.2 | 9 | 44.5 | 33.3 |
| Comp Ex H | 3 | 17.7 | 10 | 49.0 | 33.3 |
| Comp Ex I | 7 | 12.6 | 9 | 54.1 | 33.3 |
| Comp Ex J | 7 | 12.6 | 9 | 54.1 | 33.3 |
| Comp Ex K | 8 | 18.6 | 12 | 48.1 | 33.3 |
| Ex 1 | 8 | 15.6 | 3 | 51.1 | 33.3 |
| Ex 2 | 3 | 14.7 | 5 | 51.7 | 33.3 |
| Ex 3 | 8 | 15.5 | 5 | 51.2 | 33.3 |
| Ex 4 | 3 | 14.5 | 3 | 51.8 | 33.3 |
| Ex 5 | 2 | 12.6 | 3 | 54.1 | 33.3 |
| Ex 6 | 4 | 12.3 | 5 | 54.8 | 33.3 |

TABLE 5

| | | | | | | | | | EO content |
|---|---|---|---|---|---|---|---|---|---|
| | | | | | | | mol % | PO content | (wt % of |
| | | | | | | | primary | (wt % of | silicone |
| Sample | x | y | x + y | n | m | e | terminal —OH | EO + PO) | polyether) |
| Comp Ex A | 8.7 | 3.7 | 12.4 | 11.4 | 0 | 0 | >95 | 0.00 | 64.4 |
| Comp Ex B | 25 | 6 | 31 | 10 | 4 | 0 | <15 | 34.5 | 41.2 |
| Comp Ex C | 14 | 2 | 16 | 11 | 5 | 9.5 | >85 | 24.0 | 49.2 |
| Comp Ex D | 14 | 2 | 16 | 11 | 2.5 | 13 | >90 | 11.9 | 57.2 |
| Comp Ex E | 21 | 2.3 | 23.3 | 11 | 2.5 | 13 | >90 | 11.9 | 53.0 |
| Comp Ex F | 14 | 2 | 16 | 28 | 0 | 0 | >95 | 0.0 | 65.2 |
| Comp Ex G | 14 | 2 | 16 | 30 | 0 | 0 | >95 | 0.0 | 66.7 |
| Comp Ex H | 21 | 2.3 | 23.3 | 25 | 0 | 0 | >95 | 0.0 | 57.7 |
| Comp Ex I | 21 | 2.3 | 23.3 | 28 | 0 | 0 | >95 | 0.0 | 60.4 |
| Comp Ex J | 32 | 4 | 36 | 25 | 0 | 0 | >95 | 0.0 | 61.4 |
| Comp Ex K | 14 | 2 | 16 | 30 | 2.5 | 0 | <25 | 9.9 | 62.1 |
| Ex 1 | 14 | 2 | 16 | 11 | 2.5 | 20 | >95 | 9.5 | 63.2 |
| Ex 2 | 21 | 2.3 | 23.3 | 11 | 2.5 | 20 | >95 | 9.5 | 59.2 |
| Ex 3 | 14 | 2 | 16 | 11 | 2.5 | 20 | >95 | 9.5 | 63.2 |
| Ex 4 | 21 | 2.3 | 23.3 | 11 | 2.5 | 20 | >95 | 9.5 | 59.2 |
| Ex 5 | 23 | 3.6 | 26.6 | 11 | 2.5 | 20 | >95 | 9.5 | 65.7 |
| Ex 6 | 50 | 7.2 | 57.2 | 11 | 2.5 | 20 | >95 | 9.5 | 65.1 |

### Preparation of Polyol Compositions

Prepare a polyol composition, one with each of the samples of silicone polyether of Table 5, using the following procedure with components and formulations in Table 6. Characterize the polyol compositions for stability as described below.

Combine the polyol, fire retardant, water, catalysts and silicon polyether in the amounts in Table 6 and stir in a container with a 5-centimeter (2-inch) Cowles mixer blade at 2000 rpm until homogeneous. Add blowing agent and further mix until a white emulsion forms, which is the polyol composition. Weigh the mixture to allow determine if any blowing agent was lost during mixing and add additional blowing agent to reach the target amount. Fill two 40 milliliter glass vials with emulsion and then seal the vials. Split the remaining emulsion into storage containers and seal them to prevent blowing agent loss. Place one vial and one storage container into storage at 27° C. and the other vial and storage container into storage at 10° C.

TABLE 6

| Component | Description | Source | Amount (g) |
|---|---|---|---|
| Polyol | Ethoxylated propoxylated | Prepare by | 200 |
| | glycerine polyether triol. | polymerizing a | |
| | Functionality (Average | mixture of 66 wt % | |
| | OH/molecule) = 3 and Eq Wt | ethylene oxide | |
| | (molecular weight/Functionality) | and 34 wt % | |
| | of 150. EO content is greater | propylene oxide | |
| | than 50 wt % of all alkoxy in | onto glycerin. | |
| | molecule. | | |
| Fire Retardant | Tris(chloroisopropyl) phosphate | Sigma-Aldrich | 20 |
| Silicon Polyether | See Table 5 | Prepare as described | 5 |
| | | herein above | |
| Water | Water | | 0.5 |
| Blowing agent | n-pentane | Fisher Scientific | 70.2 |
| Catalyst 1 | Pentamethyl diethylenetriamine | JEFFCAT ™ | 0.76 |
| | | PMDETA from | |
| | | Huntsman | |
| Catalyst 2 | Potassium ethyl hexanoate in | DABCO ™ K-15 | 15.34 |
| | ethylene glycol | from Evonik | |
| Catalyst 3 | Potassium acetate in ethylene | POLYCAT ™ 46 | 4.38 |
| | glycol | from Evonik | |

JEFFCAT is a trademark of JP Morgan Chase Bank. DABCO and POLYCAT are trademarks of Evonik Operations GMBH.

### Polyol Composition Stability Evaluation

Evaluate the stability of the polyol compositions by visually examining the vials for each polyol composition once per day for signs of phase separation such a formation of a clear layer on the top of the white emulsion, separation of the vial contents into two distinguishable layers, or transition of any part of the emulsion from white emulsion to transparent, translucent liquid. Record the number of days it takes for evidence of phase separation to appear. The more days it takes for phase separation to appear the more stable the polyol composition. Table 7 reports the number of days required to see evidence of phase separation for the sample polyol compositions.

### Foam Appearance Testing

After 6 days of storage, blend 60 g of polyol composition with 141.2 g of polymethylenepolyphenylisocyanate (CAS 9016-87-9, available as PAPI 580N from The Dow Chemical Company) and thoroughly mix with a 5-centimeter (2-inch) Cowles mixer blade at 3000 rpm for 5 seconds. Pour the resulting mixture into a 25 cm×25 cm×10 cm box and allow to form a foam. Follow this procedure for both the sample stored at 27° C. and the sample stored at 10° C.

Characterize the resulting foam as follows. Record the degree of rise height of the foam relative to the height of the box. Full rise means the foam filled the entire box height. After recording degree of foam height remove the foam from the box. Cut the foam in half parallel with the foam rise and visually observe the surface of the cut surface cross section of the foam for signs of deviation from uniform texture and color. Signs of deviation from uniform texture and color includes large, visible holes and non-uniform color shades. Table 7 reports results of the foam appearance testing for foams made using the sample polyol compositions.

The data of Table 7 reveal that polyol compositions made using polyol compositions of the present invention were stable to phase separation for over 6 days both at 27° C. and 10° C., and even after storage at both temperatures produced foam with uniform color and texture and full rise. In contrast, polyol compositions containing silicone polyethers outside the scope of the presently claimed invention were unable to remain stable from phase separation for even close to 6 days at both temperatures or produce foam with uniform color and texture and full rise after storage at both temperatures.

TABLE 7

| | Days to visually Observe | | | |
|---|---|---|---|---|
| | signs of Separation | | Foam Appearance | |
| | 27° C. | 10° C. | 27° C. | 10° C. |
| Sample | Sample | Sample | Sample | Sample |
| Comp | <1 | <1 | Large holes, | Large holes, |
| Ex A | | | non-uniform | non-uniform |
| | | | color. | color. |
| Comp | <1 | <1 | Large holes, | Large holes, |
| Ex B | | | non-uniform | non-uniform |
| | | | color. | color. |
| Comp | <1 | <1 | Large holes, | Large holes, |
| Ex C | | | non-uniform | non-uniform |
| | | | color. | color. |
| Comp | <1 | <1 | Large holes, | Large holes, |
| Ex D | | | non-uniform | non-uniform |
| | | | color. | color. |
| Comp | <1 | <1 | Large holes, | Large holes, |
| Ex E | | | non-uniform | non-uniform |
| | | | color. | color. |
| Comp | 6 | <1 | Uniform color | Large holes, |
| Ex F | | | and texture, | non-uniform |
| | | | full rise. | color. |
| Comp | >6 | <1 | Uniform color | Large holes, |
| Ex G | | | and texture, | non-uniform |
| | | | full rise. | color. |
| Comp | <1 | <1 | Large holes, | Large holes, |
| Ex H | | | non-uniform | non-uniform |
| | | | color. | color. |
| Comp | >6 | <1 | Uniform color | Large holes, |
| Ex I | | | and texture, | non-uniform |
| | | | full rise. | color. |
| Comp | <2 | <1 | Large holes, | Large holes, |
| Ex J | | | non-uniform | non-uniform |
| | | | color. | color. |
| Comp | <1 | <1 | Large holes, | Large holes, |
| Ex K | | | non-uniform | non-uniform |
| | | | color. | color. |
| Ex 1 | >6 | >6 | Uniform color | Uniform color |
| | | | and texture, | and texture, |
| | | | full rise. | full rise. |
| Ex 2 | >6 | >6 | Uniform color | Uniform color |
| | | | and texture, | and texture, |
| | | | full rise. | full rise. |
| Ex 3 | >6 | >6 | Uniform color | Uniform color |
| | | | and texture, | and texture, |
| | | | full rise. | full rise. |
| Ex 4 | >6 | >6 | Uniform color | Uniform color |
| | | | and texture, | and texture, |
| | | | full rise. | full rise. |
| Ex 5 | >6 | >6 | Uniform color | Uniform color |
| | | | and texture, | and texture, |
| | | | full rise. | full rise. |
| Ex 6 | >6 | >6 | Uniform color | Uniform color |
| | | | and texture, | and texture, |
| | | | full rise. | full rise. |

What is claimed is:

1. A polyol composition comprising a polyol, a blowing agent, and a silicone polyether; wherein the silicone polyether has an average chemical formula (I): 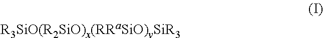
where:
(a) each R is independently in each occurrence selected from alkyl groups having from one to 4 carbon atoms;
(b) subscript x has an average value in a range of 5 to 55;
(c) subscript y has an average value in a range of one to 10;
(d) the sum of x+y has an average value in a range of 6 to 60; and
(e) R^{a} has an average chemical formula (II): 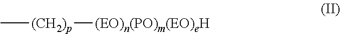
where:
(i) EO refers to —CH₂CH₂O—;
(ii) PO refers to —CH₂CH(CH₃)O—;
(iii) subscript e has an average value in a range of one to 50;
(iv) subscript m has an average value in a range of 2 to 10;
(v) subscript n has an average value in a range of one to 20;
(vi) the sum of subscript e and n has an average value in a range of 25 to 70; and
(vii) subscript p has an average value in a range of one to 11; provided that the PO content is greater than zero and at the same time less than 15 weight-percent of the combined weight of EO and PO, the EO content is greater than 58 weight-percent and at the same time less than 75 weight-percent of the weight of the silicone polyether, and
wherein the blowing agent is more than 70 volume-percent hydrocarbon blowing agent based on blowing agent volume and wherein at least one of the following conditions is met:
(f) R^{a} has a number average molecular weight in a range of 1500 to 2500 grams per mole as determined by size exclusion chromatography; and
(g) the sum of the average value for subscripts x and y is 50 or less.

2. The polyol composition of claim 1, wherein the polyol composition is further characterized by containing less than 5 mole-percent, based on total moles of silicone polyether with Formula (I), of a variation of the silicone polyether of Formula (I) that has the chemical Formula (II) terminated with a non-primary OH.

3. The polyol composition of claim 1, wherein the blowing agent is free of hydrofluorocarbons and hydrochlorofluorocarbons.

4. The polyol composition of claim 1, wherein the polyol composition is free of halogenated blowing agents.

5. The composition of claim 1, wherein the polyol is selected from polyether polyols and polyester polyols.

6. The polyol composition of claim 1, where the polyol is an alkoxy polyol and contains greater than 50 weight-percent EO based on alkoxy weight in the polyol.

7. The polyol composition of claim 1, wherein each R is methyl, subscript x has an average value in a range of 14 to 50, subscript y has an average value in a range of 2 to 7, x+y has an average value in a range of 16 to 60, subscript e has an average value of 20, subscript n has an average value of 11, subscript m has an average value of 2.5, subscript p has an average value of 3, the PO content is 9 to 10 weight-percent of the combined weight of EO and PO, the EO content is 59 to 66 weight-percent of the weight of the silicone polyether.

8. A process for preparing polymeric foam, the process comprising combining the polyol composition of claim 1 with a composition comprising isocyanate functional components.

9. The process of claim 8, further characterized by first preparing the polyol composition and then allowing it to age for a day or longer at a temperature in a range of 10 to 30° C. prior to combining with a composition comprising isocyanate functional components.
